(19) United States
(12) Patent Application Publication
(10) Pub. No.: US 2007/0108707 A1
(43) Pub. Date: May 17, 2007

(54) Stabilizer control apparatus

(75) Inventor: Hideyuki Kobayashi, Toyota-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/599,451

(22) Filed: Nov. 15, 2006

(30) Foreign Application Priority Data
Nov. 16, 2005 (JP) 2005-331115

(51) Int. Cl. B60G 17/016; B60G 21/055

(52) U.S. Cl. 280/5.511; 280/124.107; 280/5.508

(57) ABSTRACT

A stabilizer control apparatus includes a first torsion bar, a second torsion bar, and a connecting and disconnecting means including a rotation member rotating as a unit with the first torsion bar, and a housing accommodating therein the rotation member so as to be rotatable and forming two pressure chambers, the two pressure chambers being filled with a fluid. The connecting and disconnecting means generates a connecting state in which a movement of the fluid to the two pressure chambers is blocked so that a relative rotation between the first torsion bar and the second torsion bar is prohibited and a disconnecting state in which a movement of the fluid to the two pressure chambers is allowed so that the relative rotation between the first torsion bar and the second torsion bar is allowed.

### CROSS REFERENCE TO RELATED APPLICATIONS

This application is based on and claims priority under 35 U.S.C. § 119 to Japanese Patent Application No. 2005-331115, filed on Nov. 16, 2005, the entire content of which is incorporated herein by reference.

### FIELD OF THE INVENTION

This invention generally relates to a stabilizer control apparatus for a vehicle.

### BACKGROUND

A known stabilizer of a vehicle is provided between a right wheel and a left wheel of a front wheel side, a rear wheel side, or both thereof of a vehicle, and functions as a torsion spring when a relative displacement difference occurs in a suspension stroke between the right wheel and the left wheel. A stabilizer control apparatus is known as changing a torsional rigidity of the stabilizer. JP2000-289427A, for example, discloses a stabilizer control apparatus in which a torsion portion of a stabilizer is divided into a right portion and a left portion. In order to achieve both an effective roll control on a turning road, and the like, and a superior ride comfort during a straight-ahead running, respective ends of the right portion and the left portion face each other and between which a clutch mechanism is arranged for connecting and disconnecting the right portion and the left portion. The clutch mechanisms of a spline engagement type and of an operation pin type are disclosed in JP2000-289427A.

Further, JP2000-289427A discloses a hydraulic cylinder device for allowing a connecting rod in a connecting rod assembly connected to a right suspension portion or a left suspension portion to freely elongate or contract, or for locking a movement of the connecting rod. When a vehicle is running at a high speed or turning, an operation piston of the cylinder device is locked so that the connecting rod assembly is prevented from elongating or contracting. On the other hand, when a vehicle is straight running at a low speed, the operation piston is allowed to move freely so that the connecting rod assembly as a hole can freely elongate or contract.

Since the stabilizer control apparatus intends to improve a ride comfort in the straight running state and to prevent a roll motion in the turning state, the torsional rigidity can be changed by means of an operation of a drive such as a manual switch. Then, the torsional rigidity is immediately switched before a vehicle starts the roll motion, i.e. when the vehicle is straight running or the roll motion is slightly generated.

According to the disclosed stabilizer control apparatus, when the right portion and the left portion of the torsion portion of the stabilizer is connected or disconnected by the clutch mechanism of spline engagement type or of operation pin type, a torsion is generated in the stabilizer control apparatus when the vehicle is stopped or straight running. The spline, the operation pin, and the like receive that torsion, which may prevent a smooth connection or disconnection of the clutch mechanism.

Meanwhile in the case that the connecting rod is allowed to elongate or contract, or is locked by the cylinder device, a suspension stroke difference for changing the torsional rigidity of the stabilizer is difficult to be secured and otherwise a large apparatus is required.

Thus, a need exists for a stabilizer control apparatus that can have a small structure and can immediately and appropriately switch a torsional rigidity.

### SUMMARY OF THE INVENTION

According to an aspect of the present invention, a stabilizer control apparatus includes a first torsion bar connected to one of the right wheel and the left wheel of the vehicle, a second torsion bar connected to the other one of the right wheel and the left wheel of the vehicle, and a connecting and disconnecting means including a rotation member disposed between the first torsion bar and the second torsion bar and rotating as a unit with the first torsion bar, and a housing accommodating therein the rotation member so as to be rotatable and forming two pressure chambers between the rotation member in a circumferential direction, the housing being in contact with the second torsion bar, the two pressure chambers being filled with a fluid. The connecting and disconnecting means generates a connecting state in which a movement of the fluid to the two pressure chambers is blocked so that a relative rotation between the first torsion bar and the second torsion bar is prohibited and a disconnecting state in which a movement of the fluid to the two pressure chambers is allowed so that the relative rotation between the first torsion bar and the second torsion bar is allowed. The stabilizer control apparatus further includes a switching means for switching a state of the connecting and disconnecting means between the connecting state and the disconnecting state.

According to another aspect of the present invention, a stabilizer control apparatus includes a first torsion bar connected to one of the right wheel and the left wheel of the vehicle, a second torsion bar connected to the other one of the right wheel and the left wheel of the vehicle, an intermediate bar arranged between the first torsion bar and the second torsion bar, and a connecting and disconnecting means including a rotation member rotating as a unit with one end portion of the intermediate torsion bar and the first torsion bar, and a housing accommodating therein the rotation member so as to be rotatable and forming two pressure chambers between the rotation member in a circumferential direction, the housing fixed to the other end portion of the intermediate torsion bar and the second torsion bar, the two pressure chambers being filled with a fluid. The connecting and disconnecting means generates a connecting state in which a movement of the fluid to the two pressure chambers is blocked so that a relative rotation between the first torsion bar and the second torsion bar is prohibited and a disconnecting state in which a movement of the fluid to the two pressure chambers is allowed so that the relative rotation between the first torsion bar and the second torsion bar is allowed. A stabilizer control apparatus further includes a switching means for switching a state of the connecting and disconnecting means between the connecting state and the disconnecting state.

### BRIEF DESCRIPTION OF THE DRAWINGS

The foregoing and additional features and characteristics of the present invention will become more apparent from the following detailed description considered with reference to the accompanying drawings, wherein:

FIG. 1 is a partial cross-sectional view of a stabilizer control apparatus according to a first embodiment of the present invention;

FIG. 2 is a structural view of the stabilizer control apparatus including a cross-sectional view taken along the line II-II in FIG. 1.

FIG. 3 is a flowchart of a control for switching a torsional rigidity of the stabilizer control apparatus;

FIG. 4 is a graph showing a roll characteristic of a vehicle;

FIG. 5 is a flowchart showing another example of the control for switching the torsional rigidity;

FIG. 6 is a partial cross-sectional view of a stabilizer control apparatus according to a second embodiment of the present invention;

FIG. 7 is a partial cross-sectional view of a stabilizer control apparatus according to a third embodiment of the present invention; and

FIG. 8 is a graph showing a roll characteristic of a vehicle according to the third embodiment of the present invention.

### DETAILED DESCRIPTION

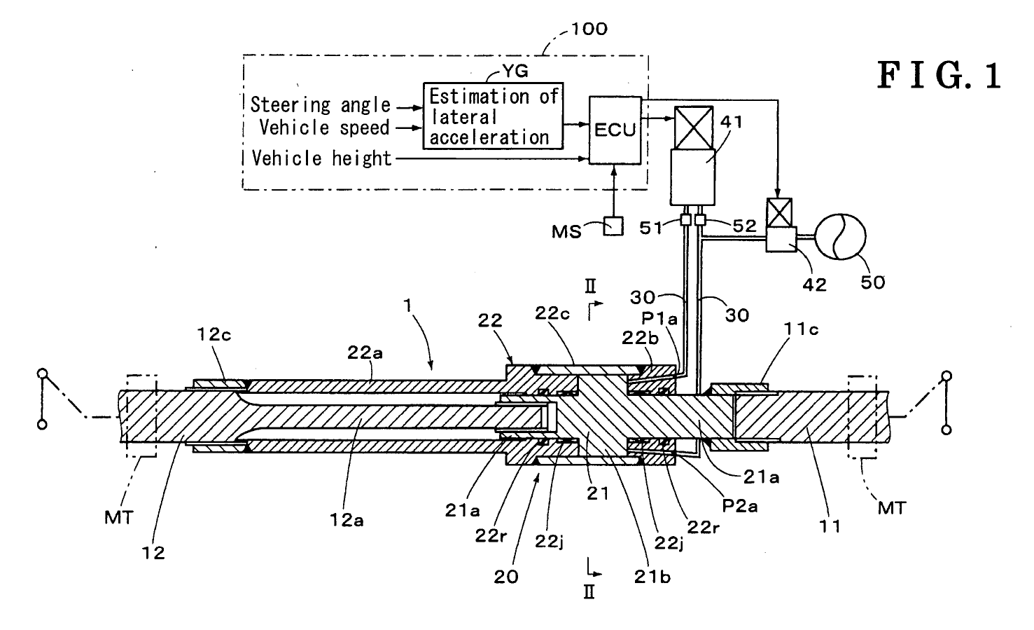

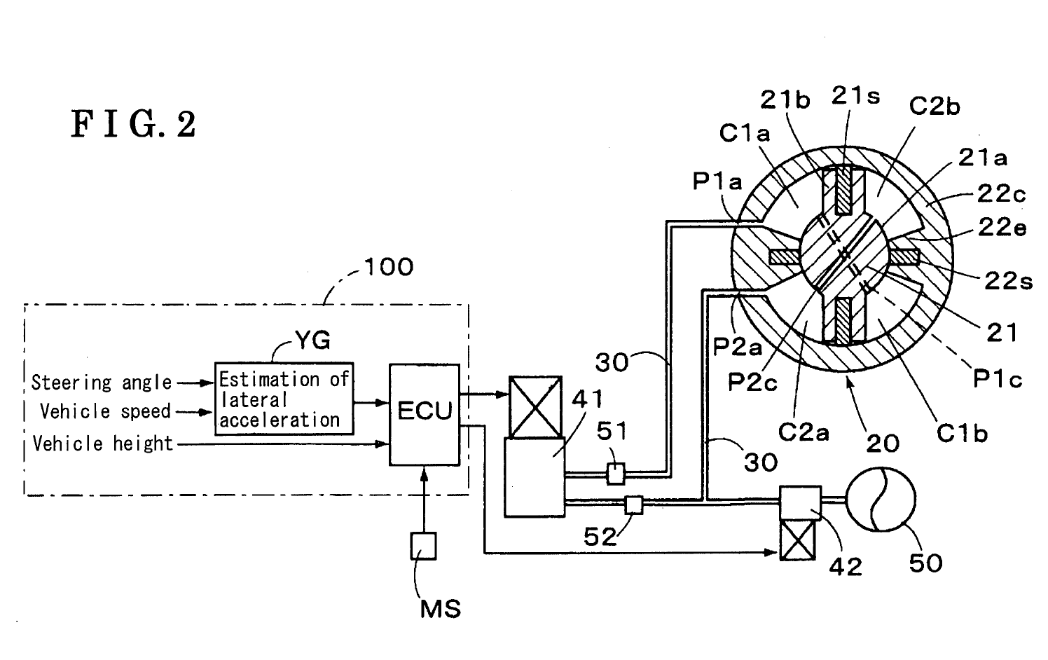

Embodiments of the present invention will be explained with reference to the attached drawings. FIGS. 1 and 2 show a structure of a stabilizer control apparatus 1 according to a first embodiment. The stabilizer control apparatus 1, which is arranged between a right wheel and a left wheel of a front wheel side, a rear wheel side, or both thereof of a vehicle, includes a first torsion bar 11 connected to one of the right wheel and the left wheel, a second torsion bar 12 connected to the other one of the right wheel and the left wheel, and an intermediate torsion bar 12a arranged between the first torsion bar 11 and the second torsion bar 12. According to the present embodiment, the intermediate torsion bar 12a is formed with the second torsion bar 12 as a unit, and of which a diameter is smaller than that of the second torsion bar 12. A spline groove is formed at an end portion of the intermediate torsion bar 12a facing a rotor 21.

A rotary valve device as a connecting and disconnecting means, i.e. a rotary valve 20, is disposed between the first torsion bar 11 and the second torsion bar 12. In the rotary valve 20, the rotor 21 (rotation member) is accommodated within a housing 22 so as to be rotatable, and a pair of vanes 21b are integrally formed on the rotor 21 in a circumferential direction thereof. As shown in FIG. 2, each vane 21b is arranged so as to be slidable to an inner periphery of the housing 22 via a seal member 21s. In this case, alternatively, the vane 21b can be formed independently of the rotor 21 and then be connected to a shaft portion of the rotor 21. Further, as shown in FIG. 2, the housing 22 includes support portions 22e extending to a rotation center of the rotor 21 so that the support portions 22e make slidably contact with an outer periphery of a shaft portion 21a of the rotor 21 via respective seal members 22s. Then, pressure chambers C1a, C1b, C2a, and C2b are defined within the housing 22 in a circumferential direction. The pressure chambers C1a and C1b are in communication with each other via a continuous bore P1c while the pressure chambers C2a and C2b are in communication with each other via a continuous bore P2c.

As shown in FIG. 2, the vanes 21b are arranged so as to face each other relative to the shaft portion 21a and to form substantially 180 degrees from each other. The support portions 22e are arranged so as to extend from the inner periphery of the housing 22 towards the shaft portion 21a and to form substantially 180 degrees from each other. Accordingly, the pressure chambers C1a and C1b are arranged in opposite directions from each other relative to the shaft portion 21a. In the same way, the pressure chambers C2a and C2b are arranged in opposite directions from each other relative to the shaft portion 21a. That is, pairs of the pressure chambers each pair having the equal pressure are formed in the opposite directions from each other relative to the shaft portion 21a. Thus, during the pressure control, the rotor 21 is prevented from being pressed to one side in the circumferential direction of the housing 22. An appropriate relative rotation can be maintained between the rotor 21 and the housing 22.

As shown in FIG. 1, the housing 22 includes three cylindrical-shaped members 22a, 22b, and 22c. The shaft portion 21a of the rotor 21 is rotatably supported by one end of the cylindrical member 22a via one of bearings 22j and one of seal members 22r. Further, the cylindrical member 22b is arranged so as to sandwich, together with the cylindrical member 22a, the vanes 21b of the rotor 21. A second end of the shaft portion 21a of the rotor 21 is rotatably supported by the cylindrical member 22b via the other one of bearings 22j and the other one of seal members 22r. Then, the cylindrical member 22c is arranged between the cylindrical members 22a and 22b in such a manner that the vanes 21b of the rotor 21 are surrounded by the cylindrical. member 22c, and is welded along a contact portion with the rotor 21 in the circumferential direction, thereby forming the pressure chambers C1a, C1b, C2a, and C2b in the circumferential direction within the housing 22 as shown in FIG. 2.

As shown in FIG. 1, a cylindrical-shaped tightening member 12c is welded and connected to the other end of the cylindrical member 22a. The cylindrical tightening member 12c is spline connected to the second torsion bar 12. In addition, a recess portion is formed on a surface of a first end of the shaft portion 21a of the rotor 21 and into which an end portion of the intermediate torsion bar 12a is received and spline connected. On the other hand, a cylindrical tightening member 1c is welded and connected to the second end of the shaft portion 21a of the rotor 21. The tightening member 11c is spline connected to the first torsion bar 11.

The first torsion bar 11 and the second torsion bar 12 are rotatable as a unit via the intermediate torsion bar 12a and the shaft portion 21a of the rotor 21. The housing 22 is rotatable as a unit with the second torsion bar 12. In addition, the housing 22 is supported by the shaft portion 21a of the rotor 21 that is rotatably supported within the housing 22. That is, consequently, the housing 22 is supported by the first torsion bar 11 so as to be rotatable relatively thereto. The first torsion bar 11 and the second torsion bar 12 are assembled onto a vehicle body (not shown) by means of mounts MT, respectively, shown by a chain double-dashed line in FIG. 1. In this case, alternatively, the rotor 21 can be connected to one end of the intermediate torsion bar 12a while the housing 22 can be fixed to the other end of the intermediate torsion bar 12a. Further, the rotor 21 can be integrally formed with the first torsion bar 11 or the intermediate torsion bar 12a.

As shown in FIGS. 1 and 2, continuous bores P1a and P2a are formed so as to open towards the pressure chambers C1a and C2a, respectively, and to which a communication passage 30 is connected. A first magnetic on-off valve 41 is provided at the communication passage 30 that brings the pressure chambers C1a and C2a to communicate with each other. In addition, an accumulator 50 is also connected to the communication passage 30 via a second magnetic on-off valve 42. Further, plugs 51 and 52 are provided at the communication passage 30. A system oil, such as a pressurized fluid that is pressurized to a predetermined pressure level, is sealingly enclosed, via the first and second magnetic on-off valves 41 and 42, the accumulator 50, the plugs 51 and 52, in the communication passage 30, and consequently the pressure chambers C1a, C1b, C2a, and C2b. The plugs 51 and 52 are retained in a closed position except after the system oil is enclosed, such as at a time of oil change, or the like. Since the communication passage 30 can be constituted by a flexible tube and thus an easy piping is available, the magnetic on-off valves 41 and 42, and the like can be arranged in an appropriate position away from the rotary valve 20, which may achieve a remote control thereof Accordingly, a degree of freedom for mounting the stabilizer control apparatus 1 in a vehicle may be increased.

Even if the system oil in the communication passage 30 and the pressure chambers C1a, C1b, C2a, and C2b is expanded due to heat, the pressure fluctuation caused thereby is absorbed by the accumulator 50. Thus, the appropriate heat expansion compensation is achieved. Further, air may be mixed in when the system oil is supplied from the plugs 51 and 52, thereby generating air form due to which fluctuation of oil pressure may occur. However, the system oil introduced to the accumulator 50 via the magnetic on-off valve 42 in an open position is brought to a predetermined pressure level. For example, even if the pressure in the communication passage 30 is decreased due to breakage of air form, the communication passage 30 is in communication with the accumulator 50 with the magnetic on-off valve 42 in the open position, thereby retaining the oil pressure within the pressure chambers C1a, C1b, C2a, and C2b to the predetermined pressure level.

As shown in FIG. 2, the magnetic on-off valves 41 and 42 are controlled to open or close by a stabilizer electronic control unit ECU within an electronic control device 100. A manual switch MS is connected to the stabilizer electronic control unit ECU so that a torsional rigidity of the stabilizer control apparatus 1 can be changed by a switch operation of a driver. In the electronic control device 100, detection signals of a steering angle of a steering wheel (not shown), a vehicle speed, and the like are input to a lateral acceleration estimation portion YG where then a lateral acceleration of a vehicle (Gy) is estimated and calculated on the basis of the input detection signals of a steering angle, a vehicle speed, and the like. When the estimated and calculated lateral acceleration (Gy) exceeds a predetermined value (in fact, before the lateral acceleration exceeds the predetermined value), the magnetic on-off valves 41 and 42 are brought to the closed position by the stabilizer electronic control unit ECU.

Further, the stabilizer electronic control unit ECU is connected to a communication bus (not shown) by means of which the stabilizer electronic control unit ECU can share a processing information in an electronic control unit for other control systems such as a brake electronic control unit, detection signals from various sensors such as vehicle heights on right and left sides obtained by a height sensor provided on right and left sides of a vehicle. A sub-routine of a common control for changing the torsional rigidity in the stabilizer control apparatus 1 is explained with reference to FIGS. 1 to 4.

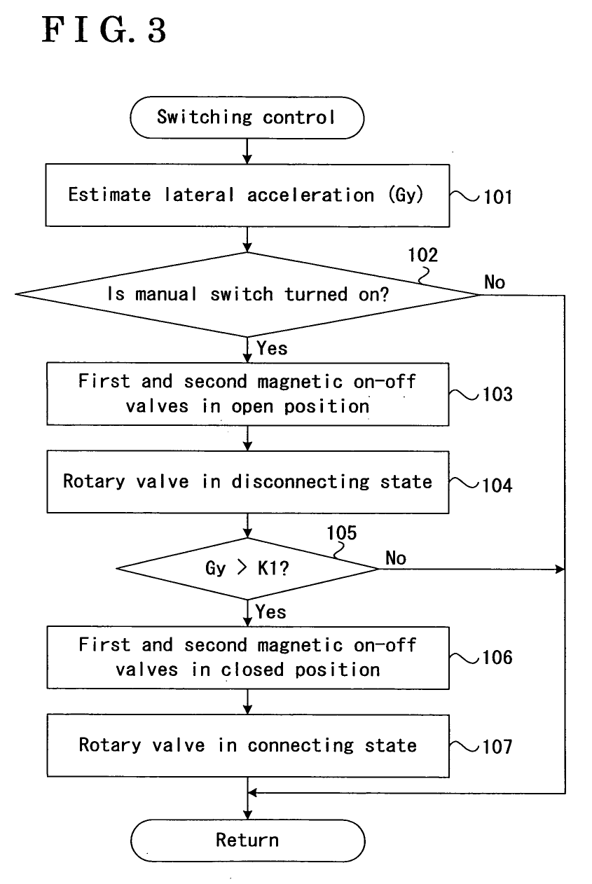

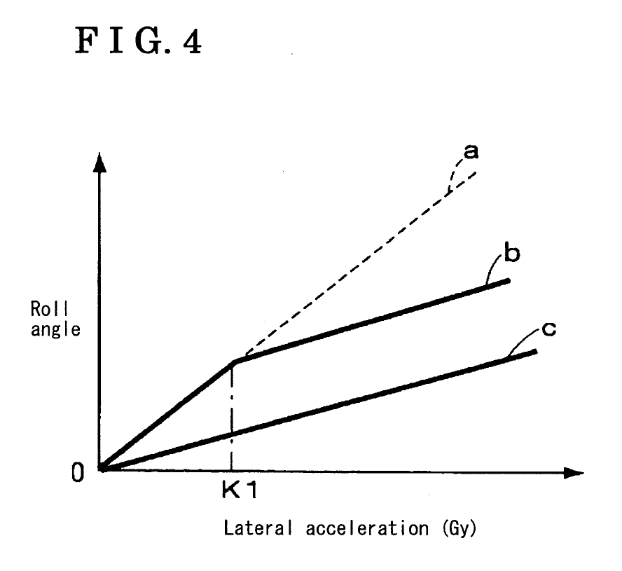

As shown in FIG. 3, in Step 101, the lateral acceleration (Gy) is estimated in the aforementioned manner. Then, in Step 102, an operation status of the manual switch MS is determined. When it is determined that the manual switch MS is turned off, a process proceeds to a main routine (not shown). When it is determined that the manual switch MS is turned on, the process proceeds to Step 103 in which the first magnetic on-off valve 41 and the second magnetic on-off valve 42 are brought to the open position. As a result, as shown in FIG. 2, the pressure chamber C1a in communication with the pressure chamber C1b via the continuous bore P1c is connected to the pressure chamber C2a via the continuous bore P1a, the communication passage 30, the magnetic on-off valve 41, and the continuous bore P2a, and also to the pressure chamber C2b via the continuous bore P2c. At this time, since the communication passage 30 is connected to the accumulator 50 via the magnetic on-off valve 42 in the open position, the oil pressure in the pressure chambers C1a, C1b, C2a, and C2b is maintained at the predetermined pressure level. In Step 104, the rotary valve 20 is in a disconnecting state (free state) and thus the torsional rigidity by the first torsion bar 11, the second torsion bar 12, and the intermediate torsion bar 12a is obtained. The roll characteristic of a vehicle at this time is shown by a in FIG. 4.

In Step 105, the lateral acceleration (Gy) estimated in the aforementioned manner is compared with a predetermined value K1. When the lateral acceleration (Gy) exceeds the predetermined value K1, it is determined that a high torsional rigidity is required. Then, in Step 106, the magnetic on-off valves 41 and 42 both are brought to the closed position. As a result, the communication between the pressure chambers C1a and C1b, and the pressure chambers C2a and C2b is cut off or prohibited. Then, in Step 107, the rotary valve 20 is in a connecting state (locked state), thereby adding the torsional rigidity by the housing 22 of the rotary valve 20 to the torsional rigidity by the first torsion bar 11, the second torsion bar 12, and the intermediate torsion bar 12a. That is, as shown in FIG. 4, the roll characteristic of a vehicle at this time is switched to b at a point of K1 in FIG. 4, b being obtained by superimposing the roll characteristic of c on the roll characteristic of a. Accordingly, before the actual lateral acceleration exceeds the predetermined value, a relative rotational position between the first torsion bar 11 and the second torsion bar 12 is adjusted to a desired position according to the control for switching the torsional rigidity based on the estimated lateral acceleration (Gy), thereby controlling a roll angle of a vehicle to a target value (explanation for controlling the target value is omitted). When the lateral acceleration (Gy) is determined to be equal to or smaller than the predetermined value K1 in Step 105, it is determined that the connecting state of the rotary valve 20 is not required and thus the process proceeds to the main routine with the magnetic on-off valves 41 and 42 both in the open position.

According to the stabilizer control apparatus 1 with the aforementioned structure, which is arranged between a right wheel and a left wheel of a front wheel side, a rear wheel side, or both thereof of a vehicle, when different stroke inputs are made to the right wheel and the left wheel, the torsion is generated in the first torsion bar 11, the second torsion bar 12, and the intermediate torsion bar 12a, i.e. the stabilizer control apparatus 1. Then, a force for returning the torsion, i.e. torsion spring force, is generated. The rotary valve 20 is intermittently controlled in response to the running state of the vehicle calculated on the basis of the operation of the manual switch MS or the aforementioned sensor signal and then the torsional rigidity is changed. In this case, the status of the rotary valve 20 is switched by the system oil, thereby preventing occurrence of irregular sound and achieving a smooth connection or disconnection of the stabilizer control apparatus 1. In addition, the rotary valve 20 can be easily switched to the connecting state not only when the vehicle is straight running state but also when running on the uneven surface or rough road, thereby achieving a smooth switching of the torsional rigidity.

Further, according to the present embodiment, when a difference between the respective vehicle heights on the right side and the left side obtained on the basis of the vehicle height signal that is detected in the aforementioned manner is equal to or greater than a predetermined value, the magnetic on-off valves 41 and 42 are brought to the open position by the stabilizer electronic control unit ECU. Thus, even if the vehicle is shifted from running on the uneven surface to the straight running with the rotary valve 20 in the connecting state, the vehicle can keep a stable running state without inclining.

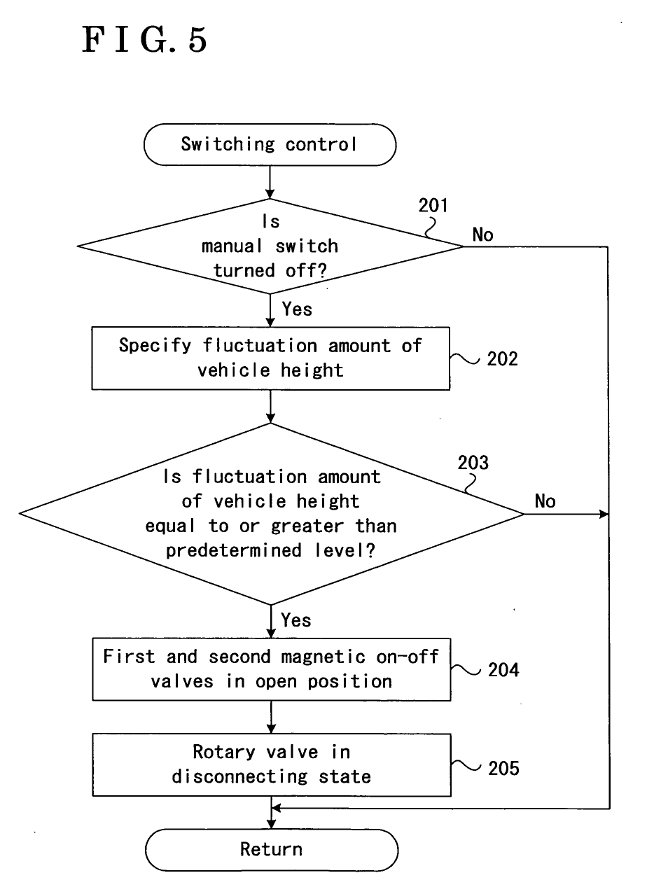

For example, the switching control by the stabilizer control apparatus 1 can be performed as shown in FIG. 5. First, in Step 201, the operation state of the manual switch MS is determined. When it is determined that the manual switch MS is turned on, the process returns to the main routine, contrary to the operation in Step 102. When it is determined that the manual switch MS is turned off, the rotary valve 20 is in the connecting state and then in Step 202, an amount of height fluctuation is specified on the basis of the height signal by the aforementioned height sensor. The amount of height fluctuation specifies a degree of fluctuation of the vehicle height. For example, the amount of height fluctuation is specified as the number of times the amount of change of vehicle height exceeds a predetermined value within a predetermined time period. Then, in Step 203, it is determined whether or not the amount of height change is equal to or greater than a predetermined level. Precisely, it is determined whether or not the number of times the amount of height change is equal to or smaller than a predetermined number. Accordingly, it is determined whether or not the vehicle is running on the uneven surface or on the rough road, i.e. rough road determination is performed. When the change amount of vehicle height is equal to or greater than the predetermined level, it is determined that the vehicle is running on the rough load. When the change amount of vehicle height is less than the predetermined level, it is determined that the vehicle is in the normal running state.

In Step 203, when it is determined that the change amount of vehicle height is equal to or greater than the predetermined level and thus the vehicle is running on the rough road, the process proceeds to Step 204 in which the magnetic on-off valves 41 and 42 are brought to the open position. Then, in Step 205, the rotary valve 20 is in the disconnecting (free) state. On the other hand, in Step 203, when it is determined that the change amount of vehicle height is smaller than the predetermined level and thus the vehicle is in the normal running state, the rotary valve 20 is kept in the connected state as is operated by the manual switch MS and not brought to the disconnecting state. According to such switching control, even if a driver of the vehicle selects the connecting state of the stabilizer through the manual switch MS, the rotary valve 20 is brought to the disconnecting state if it is determined that the vehicle is running on the rough road, thereby maintaining a comfortable ride quality even when running on the rough road.

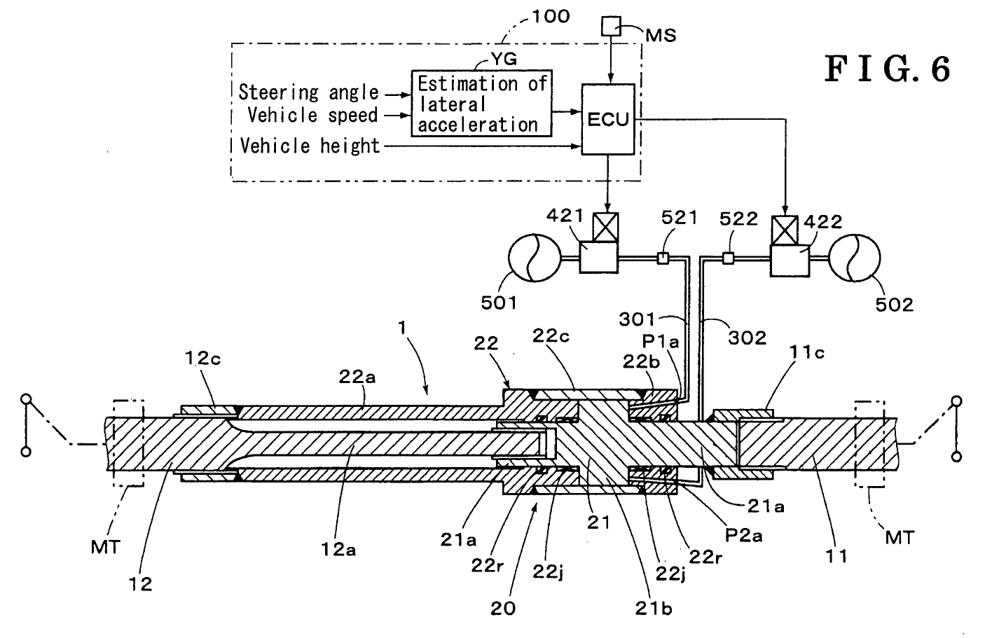

FIG. 6 shows a second embodiment of the stabilizer control apparatus l. A communication passage 301 is connected to the continuous bore P1a opening towards the pressure chamber C1a, and a communication passage 302 connected to the continuous bore P2a opening towards the pressure chamber C2a. The communication passages 301 and 302 are each made by a flexible tube, for example, and to which accumulators 501 and 502 are connected via a third magnetic on-off valve 421 and a fourth magnetic on-off valve 422, respectively. Further, plugs 521 and 522 are provided at the communication passages 301 and 302, respectively, as in the same way as the plugs 51 and 52 in FIG. 1. Accordingly, the system oil as the pressurized fluid is tightly and sealingly enclosed in the communication passages 301 and 302, and then the pressure chambers C1a, C1b, C2a, and C2b. The magnetic on-off valves 421 and 422 are controlled to open or close by the stabilizer electronic control unit ECU in the electronic control device 100.

The manual switch MS is connected to the stabilizer electronic control unit ECU and thus the torsional rigidity of the stabilizer control apparatus 1 can be changed by the switch operation of a driver. Further, according to the second embodiment, since the magnetic on-off valves 421 and 422 are individually controlled to open or close, the pressure in the pressure chambers C1a and C1b, and the pressure in the pressure chambers C2a and C2b can be individually and appropriately controlled in response to each environmental change such as an ambient temperature. Thus, the rotor 21 is rotated in a circumferential direction so as to be set in a predetermined initial position by individually controlling the magnetic on-off valves 421 and 422 to open or close in response to the environmental change of the rotary valve 20, for example. In addition, the pressure in the pressure chambers C1a and C1b, and the pressure in the pressure chambers C2a and C2b can be equal to each other so that the rotor 21 is prevented from being pressed on one side of the housing 22, thereby maintaining an appropriate relative rotation between the rotor 21 and the housing 22. The other structure of the second embodiment is same as that of the first embodiment shown in FIG. 1 and thus substantially same parts or components shown in FIG. 6 bear the same numbers in FIG. 1.

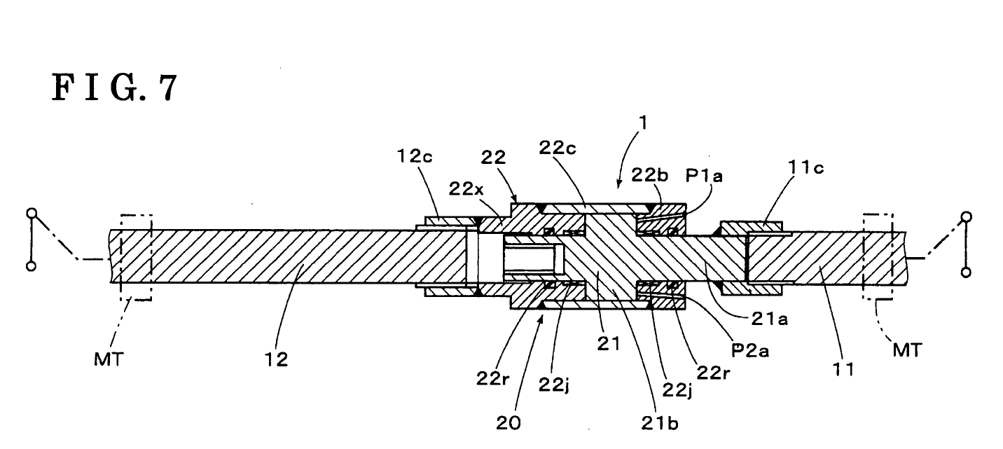

According to the structure in FIGS. 1 and 6, the first torsion bar 11 and the second torsion bar 12 are connected to each other via the intermediate torsion bar 12a. Thus, the stabilizer control apparatus 1 provides the torsional rigidity even if the rotary valve 20 is in the disconnecting state. In addition, if the rotary valve 20 fails to operate in the disconnecting state, the stabilizer control apparatus 1 can maintain a predetermined torsional rigidity. Meanwhile, according to a third embodiment shown in FIG. 7, the torsional rigidity is nil when the rotary valve 2 is in the disconnecting state. The first torsion bar 11 and the second torsion bar 12 are completely in a free state. That is, the first torsion bar 11 and the second torsion bar 12 are separated from each other, as the intermediate torsion bar 12a is not provided. Instead of the cylindrical member 22a of the housing 22, a cylindrical member 22x is used. Then, the first torsion bar 11 and the second torsion bar 12 are connected or disconnected by means of the rotary valve 20. Accordingly, when the rotary valve 20 is in the disconnecting state, the first torsion bar 11 and the second torsion bar 12 are separated from each other. The other structure of the third embodiment is same as that of the first embodiment and thus substantially same parts or components according to the third embodiment bear the same numbers.

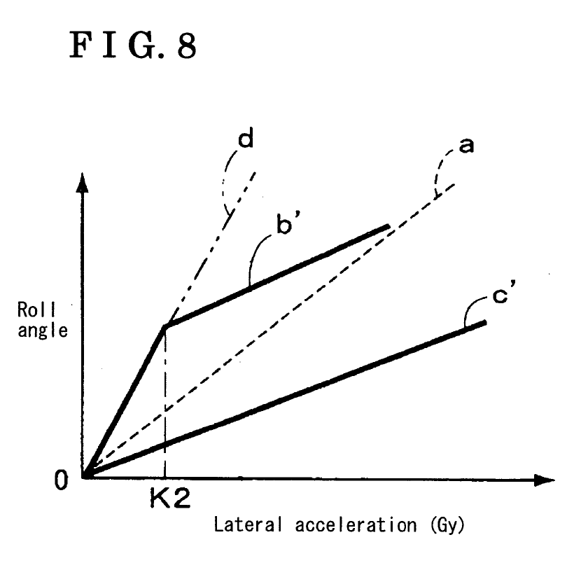

When the rotary valve 20 is in the disconnecting state (free state), the roll characteristic “d” shown in FIG. 8 is acquired. That is, the torsional force of the first torsion bar 11 and the second torsion bar 12 is not added and the roll characteristic is only achieved by a base coil spring (not shown). Thus, the stabilizer function can be cancelled especially when the vehicle is running on the rough road. When the lateral acceleration (Gy) exceeds a predetermined value K2, the rotary valve 20 is brought to the connected state, thereby switching the roll characteristic from d to b′ at a point of K2 in FIG. 8. The roll characteristic of b′ is obtained by superimposing c′ on d. According to the third embodiment, a relative rotational position between the first torsion bar 11 and the second torsion bar 12 can be also adjusted to a desired position by means of an immediate switching control based on the lateral acceleration (Gy).

According to the aforementioned embodiments, the stabilizer control apparatus 1 with a small structure can immediately and smoothly switch the torsional rigidity. For example, even in the case that the rotary valve 20 is changed to the connecting state not only when the vehicle is in the straight running state but also when the vehicle is running on the rough road, the smooth switching of the torsional rigidity of the stabilizer can be achieved. In addition, a use of fluid in the rotary valve 20 prevents generation of irregular sound and achieves smooth connection or disconnection.

Further, according to the aforementioned first and second embodiments, connecting of the first torsion bar 11 and the second torsion bar 12 can be conducted in an appropriate relative rotational position because of the intermediate torsion bar 12a, and a predetermined torsional rigidity can be assured even while the rotary valve 20 is in the disconnecting state.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A stabilizer control apparatus for controlling a torsional rigidity of a stabilizer arranged between a right wheel and a left wheel of a vehicle, comprising:
a first torsion bar connected to one of the right wheel and the left wheel of the vehicle;
a second torsion bar connected to the other one of the right wheel and the left wheel of the vehicle;
a connecting and disconnecting means including a rotation member disposed between the first torsion bar and the second torsion bar and rotating as a unit with the first torsion bar, and a housing accommodating therein the rotation member so as to be rotatable and forming two pressure chambers between the rotation member in a circumferential direction and the housing being in contact with the second torsion bar, the two pressure chambers being filled with a fluid;
the connecting and disconnecting means for generating a connecting state in which a movement of the fluid to the two pressure chambers is blocked so that a relative rotation between the first torsion bar and the second torsion bar is prohibited and a disconnecting state in which a movement of the fluid to the two pressure chambers is allowed so that the relative rotation between the first torsion bar and the second torsion bar is allowed; and
a switching means for switching a state of the connecting and disconnecting means between the connecting state and the disconnecting state.

2. A stabilizer control apparatus according to claim 1, wherein the switching means includes a communication passage for connecting the two pressure chambers to each other and for enclosing a fluid pressurized to a predetermined pressure, and a first on-off valve for opening or closing the communication passage.

3. A stabilizer control apparatus according to claim 2, wherein the switching means controls the first on-off valve to open or close in response to a running state of the vehicle.

4. A stabilizer control apparatus according to claim 2, wherein the switching means includes an accumulator connected to the communication passage and receiving a portion of the fluid enclosed in the communication passage, and a second on-off valve allowing or prohibiting a communication between the accumulator and the communication passage in response to an open and close status of the first on-off valve and maintaining a fluid pressure in the two pressure chambers at a predetermined pressure.

5. A stabilizer control apparatus according to claim 4, wherein the switching means controls to open or close the first on-off valve and the second on-off valve in response to a running state of the vehicle.

6. A stabilizer control apparatus according to claim 1, wherein the switching means includes a first communication passage connected to one of the two pressure chambers, a first accumulator connected to the first communication passage, a third on-off valve allowing or prohibiting a communication between the first accumulator and one of the pressure chambers, a second communication passage connected to the other one of the two pressure chambers, a second accumulator connected to the second communication passage, and a fourth on-off valve allowing or prohibiting a communication between the second accumulator and the other one of the pressure chambers.

7. A stabilizer control apparatus according to claim 6, wherein the switching means controls to open or close the third on-off valve and the fourth on-off valve in response to a running state of the vehicle.

8. A stabilizer control apparatus according to claim 1, further comprising: a height detecting means provided on right and left sides of the vehicle for detecting a height of the vehicle, wherein when a difference between the vehicle heights on the right side and the left side is equal to or greater than a predetermined value, the switching means switches a state of the connecting and disconnecting means to the disconnecting state.

9. A stabilizer control apparatus for controlling a torsional rigidity of a stabilizer arranged between a right wheel and a left wheel of a vehicle, comprising:
a first torsion bar connected to one of the right wheel and the left wheel of the vehicle;
a second torsion bar connected to the other one of the right wheel and the left wheel of the vehicle;
an intermediate bar arranged between the first torsion bar and the second torsion bar;
a connecting and disconnecting means including a rotation member rotating as a unit with one end portion of the intermediate torsion bar and the first torsion bar, and a housing accommodating therein the rotation member so as to be rotatable and forming two pressure chambers between the rotation member in a circumferential direction and the housing fixed to the other end portion of the intermediate torsion bar and the second torsion bar, the two pressure chambers being filled with a fluid;
the connecting and disconnecting means for generating a connecting state in which a movement of the fluid to the two pressure chambers is blocked so that a relative rotation between the first torsion bar and the second torsion bar is prohibited and a disconnecting state in which a movement of the fluid to the two pressure chambers is allowed so that the relative rotation between the first torsion bar and the second torsion bar is allowed; and
a switching means for switching a state of the connecting and disconnecting means between the connecting state and the disconnecting state.

10. A stabilizer control apparatus according to claim 9, wherein the switching means includes a communication passage for connecting the two pressure chambers to each other and for enclosing a fluid pressurized to a predetermined pressure, and a first on-off valve for opening or closing the communication passage.

11. A stabilizer control apparatus according to claim 10, wherein the switching means controls the first on-off valve to open or close in response to a running state of the vehicle.

12. A stabilizer control apparatus according to claim 10, wherein the switching means includes an accumulator connected to the communication passage and receiving a portion of the fluid enclosed in the communication passage, and a second on-off valve allowing or prohibiting a communication between the accumulator and the communication passage in response to an open and close status of the first on-off valve and maintaining a fluid pressure in the two pressure chambers at a predetermined pressure.

13. A stabilizer control apparatus according to claim 12, wherein the switching means controls to open or close the first on-off valve and the second on-off valve in response to a running state of the vehicle.

14. A stabilizer control apparatus according to claim 9, wherein the switching means includes a first communication passage connected to one of the two pressure chambers, a first accumulator connected to the first communication passage, a third on-off valve allowing or prohibiting a communication between the first accumulator and one of the pressure chambers, a second communication passage connected to the other one of the two pressure chambers, a second accumulator connected to the second communication passage, and a fourth on-off valve allowing or prohibiting a communication between the second accumulator and the other one of the pressure chambers.

15. A stabilizer control apparatus according to claim 14, wherein the switching means controls to open or close the third on-off valve and the fourth on-off valve in response to a running state of the vehicle.

16. A stabilizer control apparatus according to claim 9, further comprising:
a height detecting means provided on right and left sides of the vehicle for detecting a height of the vehicle, wherein when a difference between the vehicle heights on the right side and the left side is equal to or greater than a predetermined value, the switching means switches a state of the connecting and disconnecting means to the disconnecting state.
